(19) United States
(12) Patent Application Publication
(10) Pub. No.: US 2019/0034542 A1
(43) Pub. Date: Jan. 31, 2019

(54) INTELLIGENT AGENT SYSTEM AND METHOD OF ACCESSING AND DELIVERING DIGITAL FILES

(71) Applicant: SCRIPPS NETWORKS INTERACTIVE, INC., Knoxville, TN (US)

(72) Inventors: Al MING, Knoxville, TN (US); Mike FINKEL, Knoxville, TN (US)

(21) Appl. No.: 16/046,263

(22) Filed: Jul. 26, 2018

Related U.S. Application Data
(60) Provisional application No. 62/537,059, filed on Jul. 26, 2017.
(60) Provisional application No. 62/557,303, filed on Sep. 12, 2017.

(51) Int. Cl. G06F 17/30; G10L 15/183; G06F 3/16; G10L 15/22; G10L 15/26

(52) U.S. Cl. CPC G06F 17/30867; G06F 17/30684; G10L 15/183; G10L 2015/228; G10L 15/22; G10L 15/26; G06F 17/3043; G06F 3/167

(57) ABSTRACT

A system incorporates a speech recognition device that receives user audio signals, including speech, to automatically deliver content related to an audio or video transmission. The system performs speech recognition to identify speech recognition results and identifies tasks and actions based on the speech recognition results and on contextual information associated with the speech or the user. The system determines an intent of the speech and performs identified actions based upon the intent. In response to a user requesting a recipe detailed in video content, the system identifies the user request, identifies the video content, identifies a portion of the content from the video transmission, and delivers the content to the user. The content includes video, audio, and/or textual content and can also include setting reminders for the user, purchasing items on behalf of the user, making reservations for the user or launching applications for the user.

### CROSS-REFERENCE TO RELATED APPLICATIONS

The present application claims the benefit of U.S. Provisional Patent Application No. 62/537,059 filed on Jul. 26, 2017, and U.S. Provisional Patent Application No. 62/557,303 filed on Sep. 12, 2017, the entire contents of which are incorporated by reference.

### TECHNICAL FIELD

This technology relates to speech recognition systems and digital content distribution. More specifically, the technology relates to servicing user requests and delivering digital files to users by integrating speech recognition and natural language processing systems with video content and digital delivery systems.

### BACKGROUND

As more and more homes become wired and connected to computing devices, users can control and interact though many different means with many devices, including lighting, thermostats, televisions, DVRs, ventilation systems, air conditioning systems, security systems, home appliances, and other smart home devices. Many homes use Wi-Fi or other wireless local area networking protocols for remote monitoring and control of home automation configurations.

Many home automation systems suffer from platform fragmentation and a lack of consistent technical standards, resulting in hardware and software variations that prevent development of programs and applications that work consistently between different technology ecosystems.

As computing devices continue to evolve, new and different ways to interact with home automation systems will continue to develop. Traditional means such as keyboards, mice, and touch screens have given way to motion and gesture-activated devices. Similarly, users can employ voice-activated and voice-controlled devices to interact with and control home automation systems.

As users interact more and more with home automation systems, the average household continues to spend less and less time preparing and cooking food. Restaurants cook for us, or we buy home meal replacements or prepared foods from supermarkets. Cooking has become highly mediated and removed from daily life. Many food apps exist to facilitate meal planning and cooking and to motivate users to prepare and cook more. Many would-be cooks find it easy enough to set up a meal plan, however, they often find it difficult to maintain and stick to that plan. Many users do not have the time, patience, or inclination to dig up recipes every week or to search, access, and acquire recipes from digital sources. Previous efforts to incorporate meal planning and recipe preparation into busy lifestyles have fallen short. Users continue to look to entertainment options—TV, social media, mobile programming, digital influencers, and others—for inspiration to cook at home. While it is easy to watch a chef cook on TV, it is comparatively harder to find the recipe the chef is preparing. Prior to the existence of the Internet, cooking shows and other content providers often asked users to send a self-addressed, stamped envelope to request a recipe. When the World Wide Web appeared, the same cooking shows and content providers provided recipes from the shows and from the chefs online, but this still required users to visit the site and find the recipe by searching or browsing, often without success.

As the scope and inventory of recipes and delivery methods continues to expand, many users continue to engage with initial excitement at the prospect of cooking meals that they discover online, only to lose their motivation and neglect the process shortly thereafter. The explosion of distribution channels and recipe content results in the need for an equally convenient way of accessing recipes to make meal preparation simple, convenient, and enjoyable.

### SUMMARY

The systems and methods of the invention solve existing problems with meal planning and recipe preparation systems by integrating speech recognition and natural language processing systems with video content and digital delivery systems. According to the invention, a user may view a cooking broadcast and observe a chef preparing a meal and then receive recipes inspired by the video content. The user requests the recipe for the meal being prepared by the chef, and the recipe is delivered to the user. The systems and methods of the invention respond to voice commands to identify, access, and deliver recipes from video content programming and from various chefs. A user asks an intelligent (voice-recognizing) device for recipes by time of broadcast, recipe name, program name (of the video content), ingredient, course, or chef, and the invention determines the recipe or recipes that match the user's query. The system locates the recipe(s) in a database in a content provider computer and delivers the recipe(s) to the user. Users also can search television and other broadcast schedules by show, chef, time/date, and ingredients to find show times, episode details, and additional recipes.

The invention provides systems and methods of voice-based recipe searches and deliveries using speech recognition and natural language processing techniques. Smartphones, digital assistant systems, and mobile computing devices receive a user's spoken words, and the invention uses speech recognition and natural language processing to interpret that user's input, determine the user's intent and translate the determined intent into an action. The system then accesses a content provider that interprets the intent and performs the action, such as delivering a recipe that the user would like or has requested. The system deploys additional operations, applications, and services to deliver recipes to the user in a number of different formats.

Voice-based recipe searches improve on the prior technology in the area by greatly increasing the speed and convenience of meal planning and preparation. By combining speech recognition techniques with intelligent natural-language processing, the invention enables users to identify and request verbally a description of the recipe based on a many factors, including the current broadcast, a particular show, a particular talent (such as a chef or restauranteur), a particular ingredient, a particular restaurant, and other recipe criteria. The invention automatically identifies the recipe(s) that correspond to the description provided by the user and returns them to the user for viewing, printing, and other uses. The invention processes speech-based input to find and retrieve relevant recipes. The invention stores metadata with the recipes when they are captured or saved, and cross-references the recipes with programming and other user information to facilitate searching. For example, a broadcast schedule entry indicating that a series of broadcasts in one week were all directed to New Orleans cuisine can be used to create a search query to find recipes for dishes prepared or saved on those dates.

The invention provides systems, methods, and computer readable storage media that enable users to request and receive digital content using voice-based communications. The invention includes a content provider service that delivers video content to a user, such as on a television, computing device, kiosk, and other devices used by viewers of video content. The content provider service delivers the video content to several types of viewing devices over a communications network that links the devices and services of the invention. In some implementations of the invention, an intelligent agent (e.g., a smart speaker or digital assistant) such as Amazon Alexa, Google Assistant, Microsoft Cortana, Apple Homepod, and others, detects a user's spoken words. A speech and language processing service/computer then translates that speech into a user's intent or command and communicates the intent to the content provider service. Once the intent is received, the content provider services takes action based on the intent.

In one example implementation, a user requests a recipe from their intelligent agent from a television show that is currently being broadcast. The invention accesses the content provider service's schedule to determine what show and episode is currently playing on the user's television. Once it has received that information, the invention accesses the (video) content provider's database of episodes and recipes to retrieve the recipes in question. The invention then assembles a natural language response to the user and returns it to the user via the intelligent agent. The user may then ask for the recipes to be read, displayed, emailed, or delivered in another fashion using the intelligent agent, computing device, kiosk, and other electronic devices.

In some embodiments of the invention, the system includes intelligent agents, servers, databases, and services that include a processor, memory, and programs stored in the memory and configured to be executed by the processor(s) that include instructions for performing the operations of the methods described in this application. In some embodiments, a non-transitory computer readable storage medium stores instructions that, when executed by an electronic device, cause the device to perform the operations of the methods described in this application.

The systems and methods of the invention include a content provider computer that includes at least one processor, a memory, and one or more computer programs. The computer programs are stored in the memory and are configured to be executed by the processor(s). The program(s) include instructions for receiving a JSON package from a speech and language processing computer. The JSON package includes a messaging intent determined by performing natural language processing on text data, and the text data is generated from an audio file by performing automated speech recognition. The program(s) also include instructions for decoding the JSON package to identify the messaging intent, where the messaging intent corresponds to an action to be taken by the content provider computer. The program(s) also include instructions for determining at least one digital content item that satisfies the action of the messaging intent and for appending the JSON package to include the at least one digital content item. The program(s) include instructions for providing the appended JSON package with the at least one digital content item to the speech and language computer over a communications network.

The computer program(s) can include a recipe identification program including additional instructions for further decoding the JSON package and determining that the messaging intent includes delivery of a recipe and that the at least one digital content item includes a recipe. The recipe identification program can include additional instructions for further decoding the JSON package and comparing the decoded JSON package to intents records in an intents database in the content provider computer.

Additionally, the recipe identification program can include additional instructions for further decoding the JSON package and determining that the messaging intent includes a slot pattern including at least a target slot and a deliverables slot. The recipe identification program can include additional instructions for determining the portion of the JSON package that corresponds to the target slot and the deliverables slot and that the target slot includes a television program that is currently broadcast and that the deliverables slot includes a recipe related to the television program that is currently broadcast. The recipe identification program can include additional instructions for comparing the target slot to a schedule database and determining a television program that is currently broadcast based on schedule records in the schedule database that correspond to the target slot as well as comparing the deliverables slot to a recipe database and determining at least one recipe related to the television program based on recipe records in the recipe database that correspond to the deliverables slot. Further, the recipe identification program can include additional instructions for identifying the television program that is currently broadcast based on television program records in a content database in the content provider computer.

The recipe identification program also includes additional instructions for determining a time zone of a user based on a known user identification record, a portion of the JSON package that corresponds to a time zone record, and/or a response to a prompt from the content provider computer requesting the time zone of the user.

In some implementations of the invention, the recipe identification program including additional instructions for determining the portion of the JSON package that corresponds to the target slot and the deliverables slot and that the target slot includes a talent name and that the deliverables slot includes a recipe related to the talent name. The recipe identification program can include additional instructions for comparing the target slot to a talent database that includes talent records with television program information, comparing the talent records to a schedule database to determine broadcast dates and times of television programs featuring talent identified in the talent records, determining a television program based on the talent records and the schedule records in the schedule database that correspond to the target slot, comparing the deliverables slot to a recipe database, and determining at least one recipe related to the television program based on recipe records in the recipe database that correspond to the deliverables slot.

In some implementations of the invention, the computer program(s) includes additional instructions for confirming receipt of the appended JSON package by the speech and language processing computer and playback of a generated audio response corresponding to the appended JSON package by an intelligent agent computing device.

In some implementations of the invention, the computer program(s) includes additional instructions for further decoding the JSON package to identify a user, comparing the identified user to user records in the user database of the content provider computer, and confirming the user identity based on the comparison of the identified user and the user records. The computer program(s) can include additional instructions for determining that the user does not correspond to a user record in the user database of the content provider computer, identifying a prompt in a prompts database in the content provider computer that corresponds to a user's time zone, modifying the JSON package to include the prompt, providing the appended JSON package with the prompt to the speech and language computer over a communications network, and confirming receipt of the modified JSON package by the speech and language processing computer and playback of a generated audio response corresponding to the modified JSON package by an intelligent agent computing device, resulting in an audio prompt to a user requesting the user's time zone.

In some implementations of the invention, the computer program(s) includes additional instructions for identifying a prompt in a prompts database in the content provider computer and modifying the JSON package to include the prompt and providing the appended JSON package with the prompt to the speech and language computer over a communications network. The program(s) also include instructions for confirming receipt of the modified JSON package by the speech and language processing computer and playback of a generated audio response corresponding to the modified JSON package by an intelligent agent computing device, resulting in an audio prompt to a user.

In some implementations of the invention, the audio file generated by performing automated speech recognition includes speech data from a user received by a microphone of an intelligent agent computing device.

In some implementations of the invention, the computer program(s) includes additional instructions for sending the at least one digital content item to a user in an email over a communications network with a mail server of the content provider computer and/or sending the at least one digital content item to a user in a text message over a communications network.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows an example system architecture in accordance with the invention.

FIG. 2 shows an example intelligent agent in accordance with the invention.

FIG. 3 shows an example speech and language processing computer in accordance with the invention.

FIG. 4 shows an example content provider service in accordance with the invention.

FIGS. 5A-5B show an example process of delivering digital content based on a current broadcast in accordance with the invention.

FIG. 6 shows an example process of delivering digital content based on a requested channel in accordance with the invention.

FIG. 7 shows an example process of delivering digital content based on a requested show in accordance with the invention.

FIG. 8 shows an example process of delivering digital content based on a requested talent in accordance with the invention.

### DETAILED DESCRIPTION

The systems and methods of the invention integrate home automation systems, including those with voice-recognizing intelligent agent devices, with meal planning and recipe preparation in video content. A user views a cooking show and observes a chef preparing a meal. The user requests a recipe for the meal that the chef is preparing or other related recipes, and the system delivers the recipe(s) to the viewer. The invention responds to user voice commands to identify, access, and deliver recipes from video content programming. Users can ask an intelligent (voice-recognizing) agent for recipes by name, by program name of the video content, by date and time, by ingredient, by course, by chef, and by other video content programming information, and the invention determines the recipe or recipes that match the user's request. The system locates the recipe(s) and builds a recipe delivery file that includes recipe text, recipe photos, and links to other pages in which the user may be interested.

The system assembles and sends a natural language response to the user's request. For example, the system can respond to the user's verbal confirmation with a text file transmission indicating, “Okay, I've just sent the recipes from this episode to your email address.” The system electronically delivers the recipe file to the user. The system can deliver recipes to the user in the form of an email, text message, video file, audio file, or other digital format, depending upon the device upon which the user will receive the recipe file. Users can also search television and other broadcast schedules by show, chef, time/date, and ingredients to find show times, episode details, and recipes. The client side portion of the intelligent agent can be delivered to the user online, via an app, or as a skill, depending upon the type of electronic personal assistant used by the viewer.

### System Architecture

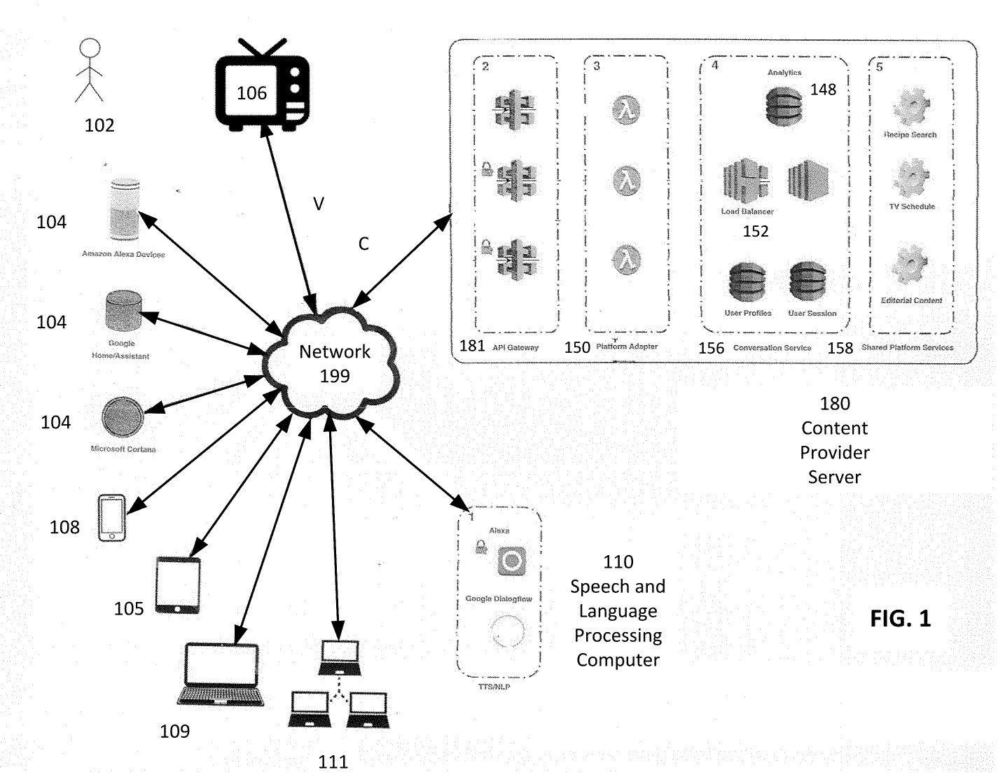

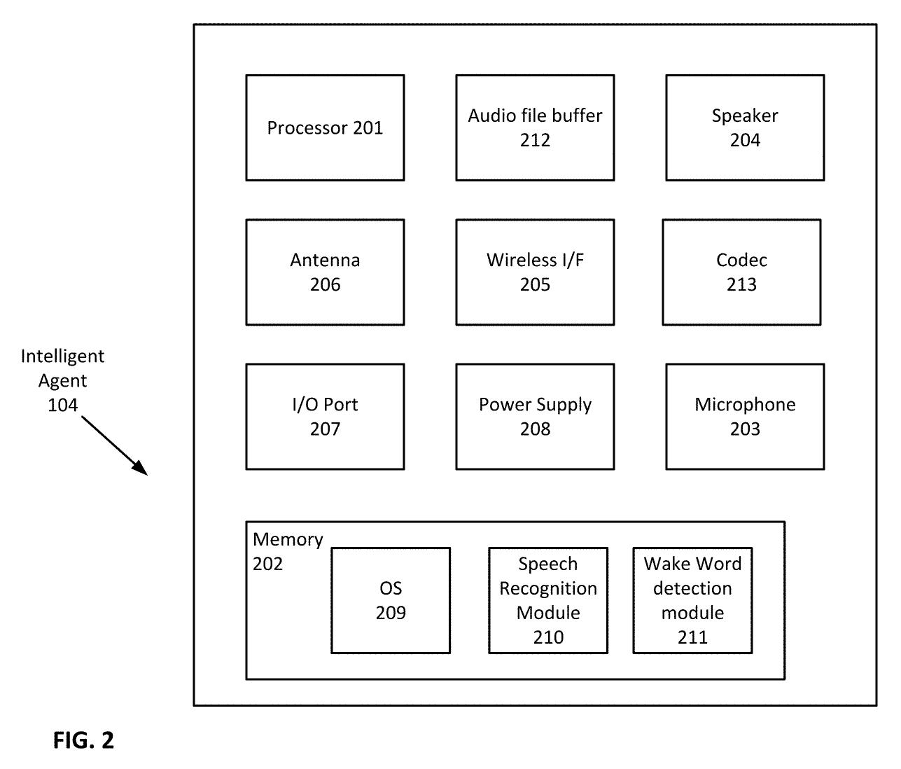

FIG. 1 shows one example system architecture 100 of the invention. A user 102 accesses a voice-activated intelligent agent 104. The voice-activated intelligent agent 104 includes at least one microphone and at least one speaker to provide audio interactions with the user 102. In some environments, voice-activated intelligent agent 104 also includes a tactile input device (e.g., keyboard, keypad, touch screen, joystick, control buttons, etc.), or a display. In other implementations, the voice-activated intelligent agent 104 may operate solely based on voice and speech commands. Users can also interact with the system 100 using other data processing devices, such as smart phones 108, laptop computers 109, tablet computers 105, handheld computers, personal digital assistants (PDAs), desktop computers, cellular telephones, enhanced general packet radio service (EGPRS) mobile phones, media players, navigation devices, game consoles, smart televisions, remote controls, or a combination of any two or more of these data processing devices or any other suitable data processing devices. Additional details of the intelligent agent 104 are provided below with reference to an example user intelligent agent 104 shown in FIG. 2.

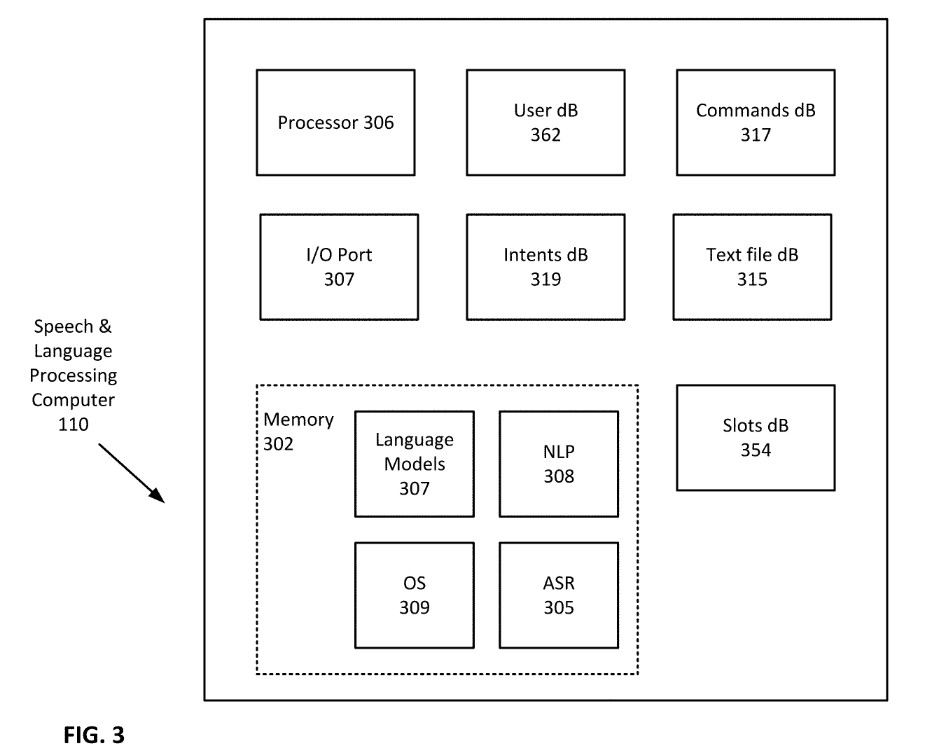

For simplicity and brevity, in this application, the examples of the invention described refer to intelligent agent devices, but other computing and data processing devices programmed with instructions to carry out the methods of the invention can also be used. The system 100 also includes a speech and language processing computer 110 that works in tandem with the voice activated intelligent agent 104 to facilitate service of user voice commands. Additional details of the speech and language processing computer 110 are provided below with reference to an example speech and language processing computer 110 shown in FIG. 3.

The devices 104-110 are connected via communication network 199. Examples of the communication network(s) 199 include local area networks (“LAN”) and wide area networks (“WAN”), e.g., the Internet. The communication network(s) 199 may be implemented using a number of network protocols, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

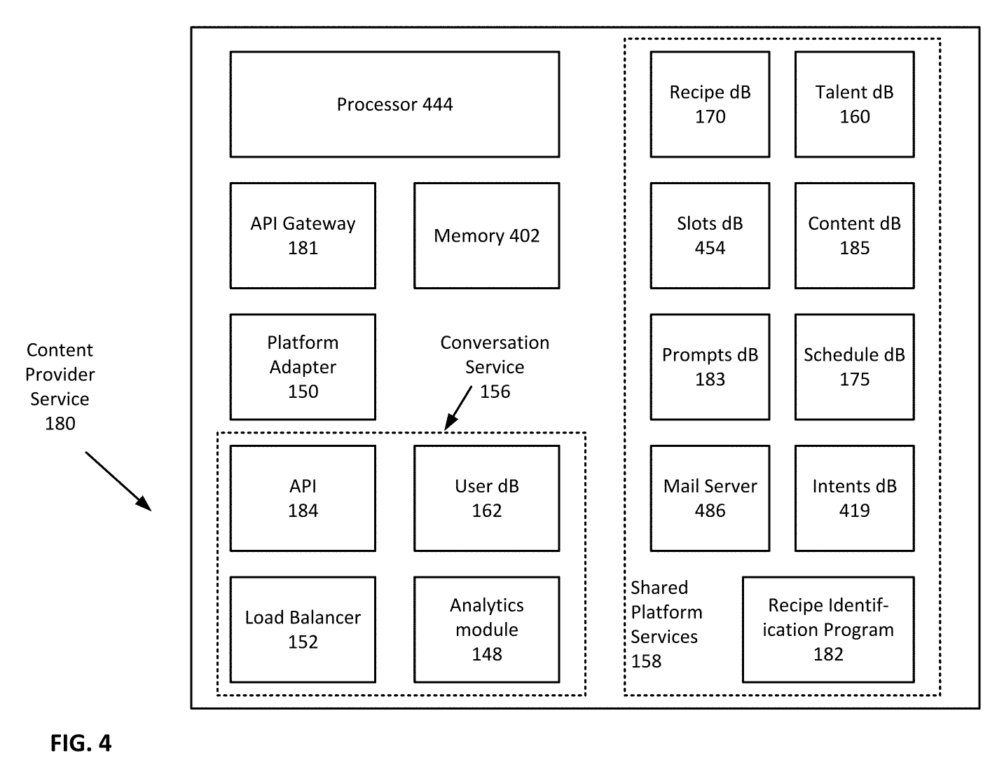

The system 100 also includes content provider service 180 connected to the communications network 199. Content provider service 180 can be a server system and can be implemented on at least one data processing apparatus and/or a distributed network of computers. In some implementations of the invention, content provider service 180 is a server system, and content provider service 180 also employs various virtual devices and/or services of third party service providers (e.g., third-party cloud service providers) to provide the underlying computing resources and/or infrastructure resources of the server system of content provider service 180. In other examples of the invention, content provider service 180 is implemented on a single physical computer. Additional details of the content provider service 180 are provided below with reference to an example content provider service 180 shown in FIG. 4.

### Example Intelligent Agent

FIG. 2 shows physical and functional components of the intelligent agent 104 in more detail. Intelligent agent 104 can be implemented as a standalone device with limited input and output components, processing, and memory capabilities. In one example implementation of the invention, the voice-controlled intelligent agent 104 does not have a keyboard, keypad, touch screen, or other form of tactile or mechanical input. The intelligent agent 104 is configured to send and receive audio with a network interface (wireless or wired), power, and processing and memory storage capabilities.

In one example implementation of the invention shown in FIG. 2, the intelligent agent 104 includes at least one processor 201 and a memory 202. The memory 202 can include computer-readable storage media, which can be any physical media accessible by the processor 201 to execute instructions stored in the memory 202. In one example implementation, the computer-readable storage media can include random access memory (RAM) and Flash memory. In other example implementations, the computer-readable storage media can include read-only memory (ROM), electrically erasable programmable read-only memory (EEPROM), and magnetic computer storage devices, such as hard disk drives, and other media which can be used to store the desired information and that can be accessed by the processor 201.

The voice-controlled intelligent agent 104 includes at least one microphone 203 to detect and receive sounds, such as the user's voice, and to generate an audio signal from the received sound. The intelligent agent 104 can also include at least one speaker 204 to output audio sounds. The intelligent agent 104 can also include at least one codec 213 coupled to the microphone 203 and speaker 204 to encode and/or decode audio signals. The codec 213 converts audio signals to/from analog and digital formats. A user 102 interacts with the intelligent agent 104 by speaking to it, and the microphone 203 receives the user's speech and generates an audio signal. The codec 213 encodes the audio signal and transfers that encoded audio signal to other components of the intelligent agent 104 or to another device, including the speech and language processing computer 110. The intelligent agent 104 communicates back to the user by playing audible statements through the speaker 204.

In the example implementation of FIG. 2, the intelligent agent 104 includes a wireless interface 205 coupled to an antenna 206 to effect a wireless connection to the network 199. The wireless interface 205 can be implemented using a number of wireless technologies, including Wi-Fi, Bluetooth, and others.

The intelligent agent 104 also includes at least one I/O port 207, such as a USB port, one or more input/output ports 216, such as a USB port, a Thunderbolt port, and other I/O ports. The I/O port 207 can be used to connect to a wired network or to a plug-in network device, such as a flash drive, a hub, and other I/O devices. The intelligent agent 104 also includes a power supply 208 to provide power to the various components of intelligent agent 104.

The intelligent agent 104 facilitates audio interactions with the user 102 by receiving voice commands and playing audible statements back to the user 102. The intelligent agent 104 receives words, phrases, sentences, and other audible input from the user and processes the speech. The intelligent agent 104 includes a number of services, instructions, and data stores in memory 202. The instructions for each are stored in memory 202 and are configured to execute on processor 201. An operating system module 209 is configured to manage hardware, software, and services (e.g., wireless unit, USB, I/O port, Codec) within and coupled to the intelligent agent 104 for use with other modules.

The memory 202 also includes a speech-recognition module 210. The speech-recognition module 210 includes language and training modules. The speech-recognition module 210 decodes the user's speech to identify sounds within an audio signal. The speech-recognition module 210 then identifies character strings that are either spoken or spelled from the audio signal based on the identified sounds. The speech-recognition module 210 can perform speech recognition based upon language models. The language models can include identifications of sounds that correspond to particular letters, numbers, symbols, and other corresponding text. The speech-recognition module 210 incorporates a training module to refine the language model(s) or other language models based on interaction with the user 102. The memory 202 also includes a wake word detection module 211 that processes the received audio from a user 102 and determines if a wake word was spoken. When the wake word detection module 211 detects a wake word, the intelligent agent 104 sends audio data corresponding to the utterance of the user 102 to the speech and language processing computer 110, which includes an automated speech recognition (ASR) module 305 (as shown further in FIG. 3).

### Example Speech and Language Processing Computer

FIG. 3 shows functional components of the speech and language processing computer 110 in more detail. Speech and language processing computer 110 can be implemented as a standalone device, including as a server system on the network 199. In other implementations of the invention, the speech and language processing computer 110 can be integrated with the intelligent agent 104. In other implementations, the functions of the intelligent agent 104 and the speech and language processing computer 110 overlap, or may be redundant. The speech and language processing computer 110 can supplement or assist the intelligent agent 104 with Automatic Speech Recognition (ASR) processing, Natural Language Processing, command processing, and generating synthesized speech. A single speech and language processing computer 110 can perform all the speech and language processing, or multiple speech and language processing computers 110 can be combined to perform the processing. Further, some of the speech detection, language processing, and command execution functions can be performed by the intelligent agent 104. The intelligent agent 104 and the speech and language processing computer 110 work in tandem to perform the functions and methods described using the combined components of the two devices.

Speech and language processing computer 110 performs natural language processing to interpret the voice commands received by the intelligent agent 104 and to transform the audio data associated with the speech into text data representative of the speech. Speech and language processing computer 110 derives meaning from the text data and determines a corresponding process to be carried out. Speech and language processing computer 110 can then send instructions to the content provider service 180 to perform the process.

The speech and language processing computer 110 receives audio data from the intelligent agent 104 (such as via I/O port 307, which can be a wired input/output or a wireless input/output port) in an automatic speech recognition (ASR) module 305. ASR module 305 converts the received audio data into text data using operating system (OS) 309. The ASR module 305 transcribes audio data into text data representing the words of the speech contained in the audio data. The text data is then used by other components of the speech and language processing computer 110 to execute system commands, input data, and other activities. A spoken utterance in the received audio data is input to a processor 306 configured to perform ASR by interpreting the utterance based on the similarity between the utterance and pre-established language models 307 stored in a memory in the speech and language processing computer 110. For example, the ASR module 305 can compare the input audio data with models for sounds (e.g., subword units or phonemes) and sequences of sounds to identify words that match the sequence of sounds spoken by the user and present in the audio data. The ASR module 305 represents the identified words as text data.

Once the ASR module 305 represents the identified words as text data, the ASR module 305 sends the text data to natural language processor (NLP) 308. The NLP 308 takes the received text data and attempts to create a semantic interpretation of the text data. The NLP 308 determines the meaning of the text data based on the individual words and phrases. The NLP 308 interprets a text string to derive an intent or a desired action from the user 102 as well as the pertinent pieces of information in the text data that allow content provider service 180 to complete that action. As described in further detail below, if a user speaks and the ASR module 305 determines the audio data is represented by the text data “turn off the lights,” the NLP 308 can determine that the user intended to de-activate a light switch in the room in which the intelligent agent 104 is present.

### Content Provider Service

Content provider service 180 provides video content C to user 102 over network 199 to a television 106 or other data processing device 104, 105, 108, 109, 111 upon which a user 102 can view content C. Content provider service 180 provides content C from content database 185. Content provider service 180 accesses, provides, tracks, and manages content C with schedule database 175 and accesses, provides, tracks, and manages recipes and restaurants and talent (e.g., chefs) with respective databases 170 and 160. The system databases 185, 175, 170, 160 can be combined in a single computer or can each be physically discrete databases and computer systems. The system 100 (including content provider service 180) accesses the databases 185, 175, 170, 160 via network 199.

The content provider 180, databases 185, 175, 170, 454, and 160, as well as speech and language processing computer 110 and its associated databases (e.g., text file database 315, user database 362, commands database 317, and intents database 319) can be embodied in a single computer device, such as a server, for example, or can be embodied in a distributed computing system, with components located in disparate systems and/or locations as shown in the example configuration in FIG. 1. Content provider service 180 includes a processor 444 and a memory 402 including instructions that are executable by the processor 444 to configure the content provider service 180 to carry out the methods and processes described in this application. Additionally, content provider service 180 includes an analytics module 148, which provides statistics compiling and tracking capabilities to the content provider service including selectively tracking and/or excluding users, monitoring the types of recipes accessed and the manner in which they are delivered, monitoring the files accessed from the databases, and other tracking and performance measures. Content provider service 180 also can include a load balancer 152, such as a multilayer switch or a Domain Name System (DNS) server process, to distribute the workload of the content provider service 180 across computing resources, such as processors, memories, and other computing resources.

The API 184, load balancer 152, analytics module 148, and user profiles (stored in user database 162 described below) provide business logic of the voice services and execute request queries and generate responses and are grouped as conversation service 156. The conversation service 156 provides request handler processes, including fetching and creating user and session contexts, determining platform types and device capabilities, and facilitating mapping of intents to handler classes. The conversation service 156 also provides intent handling, including execution of the intent command and storing data in session context. Similarly, the conversation service 156 provides response handling, including the generation of a response for each device capability (e.g., voice, screen, etc.), saving of session context, saving files for analytics, and formatting and returning the JSON package.

As also shown in FIG. 4, a number of the components of the content provider service 180 share data services between platforms and can be characterized as shared platform services 158.

For simplicity, the discussion below describes “client” devices as those in which the user 102 interacts directly, including, for example, voice-activated intelligent agent 104, and other data processing devices 104, 105, 108, 109, 111, and television 106. For simplicity and brevity, the discussion below describes the “non-client” devices as separate components, such as servers or other computer systems accessed via network 199. Users will typically access the system 100 and directly interact with intelligent agent 104, data processing devices 104, 105, 108, 109, 111, and television 106, and access the other components via network 199. The system 100 can include other components, such as firewalls, load balancers, application servers, failover servers, site management tools, and other server components as well.

Users 102 access the system 100 in a variety of ways, depending upon the type of information in which they are interested and the type of device upon which they are working. For example, a user 102 can access content information, including a particular show that is on, recipe information, and talent (e.g., television personality). Depending upon the type of interaction in which the user 102 is interested, the system 100 provides appropriate responses and options to the user 102.

In one example implementation of the invention, the user 102 views a Food Network® program C that originates with content provider service 180 and is delivered to the user's television 106 or data processing devices 104, 105, 108, 109, 111 via network 199 as video content V. The program C can be delivered as a cable television broadcast when network 199 is a cable television delivery infrastructure. Likewise, program C can be delivered as streaming video content when network 199 is a computer network, such as the Internet, for example.

### User Request Processing

Regardless of the transmission type of video content V, as the user 102 watches video content C, the user 102 requests information regarding the channel, show, recipe, and talent verbally using a smart phone or voice-activated intelligent agent 104, or other voice-recognition and processing system as described above.

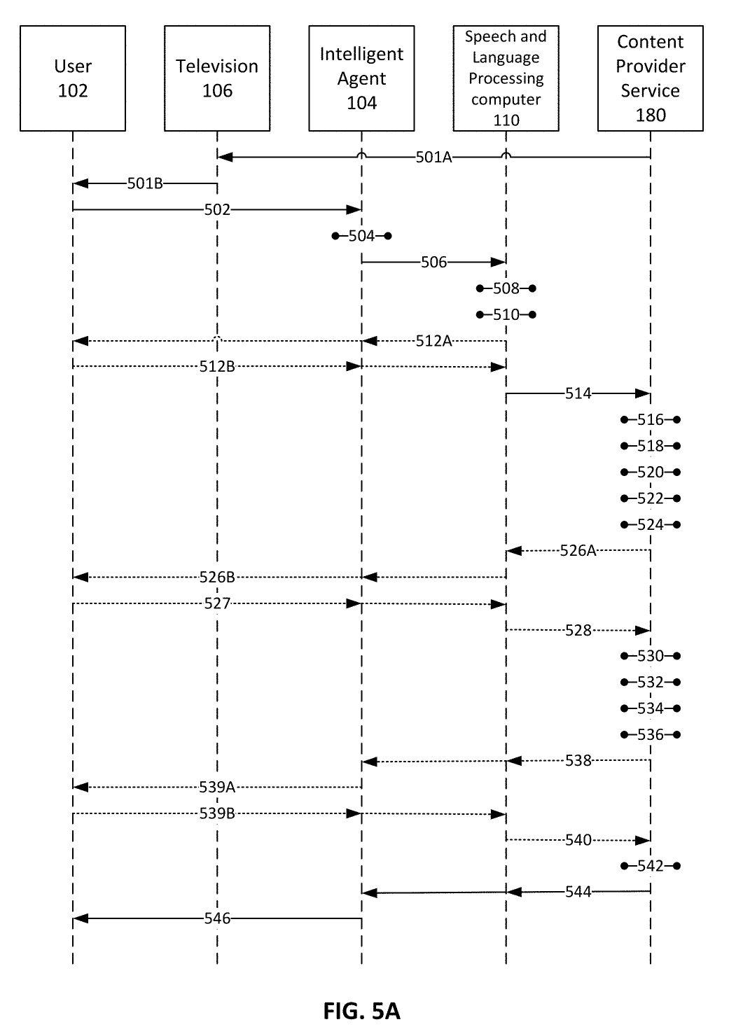

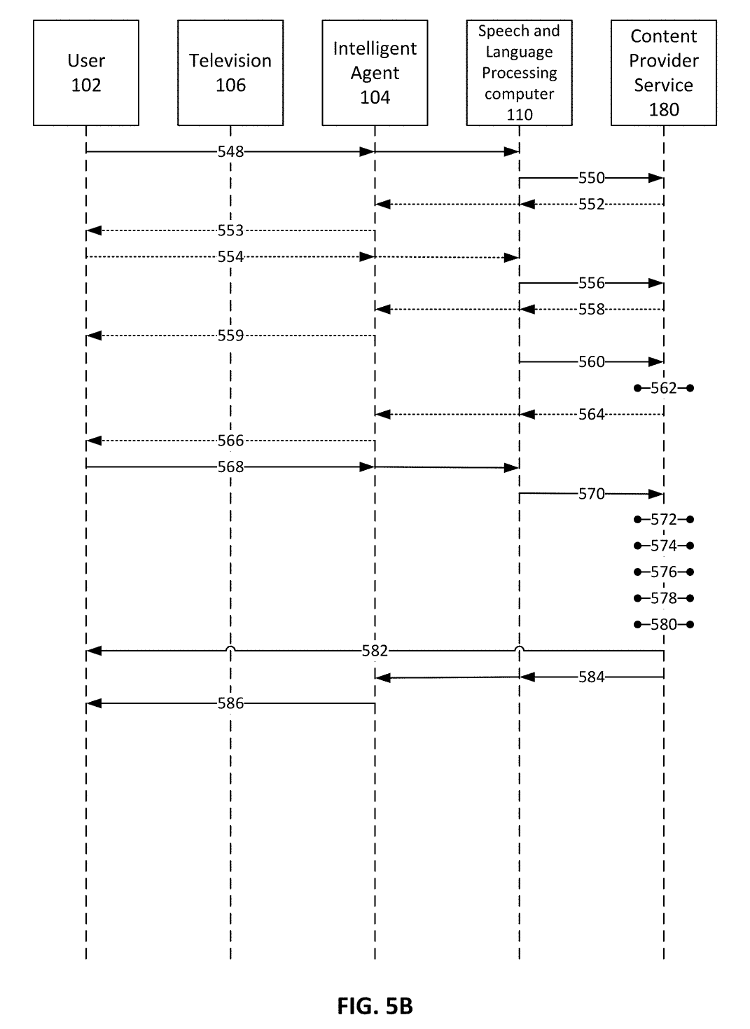

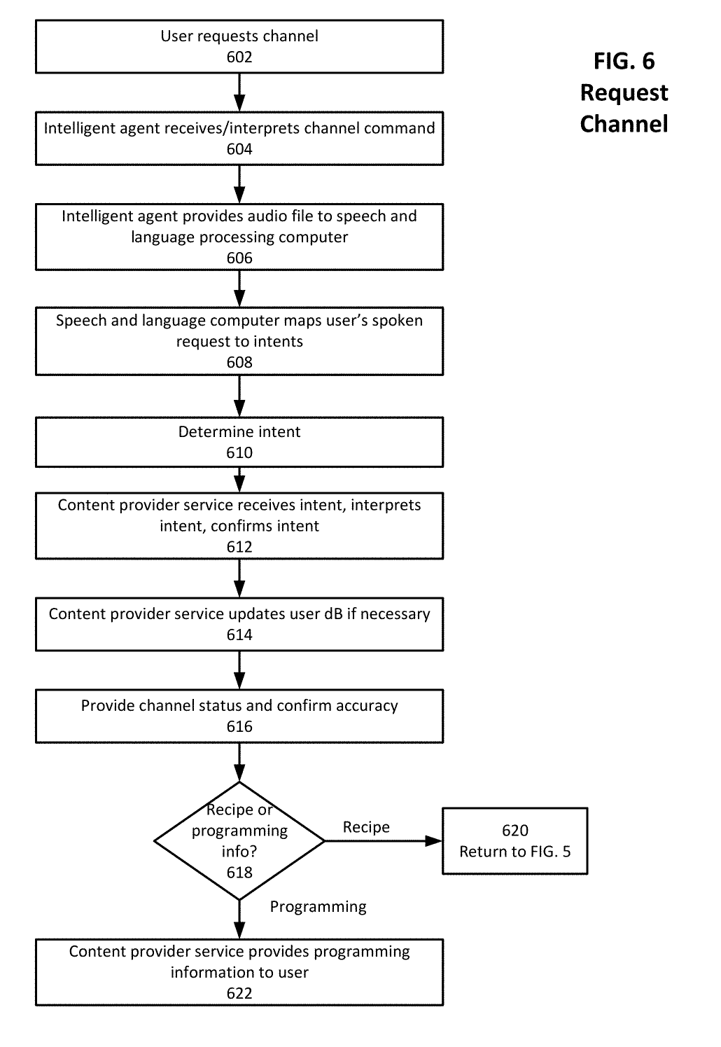

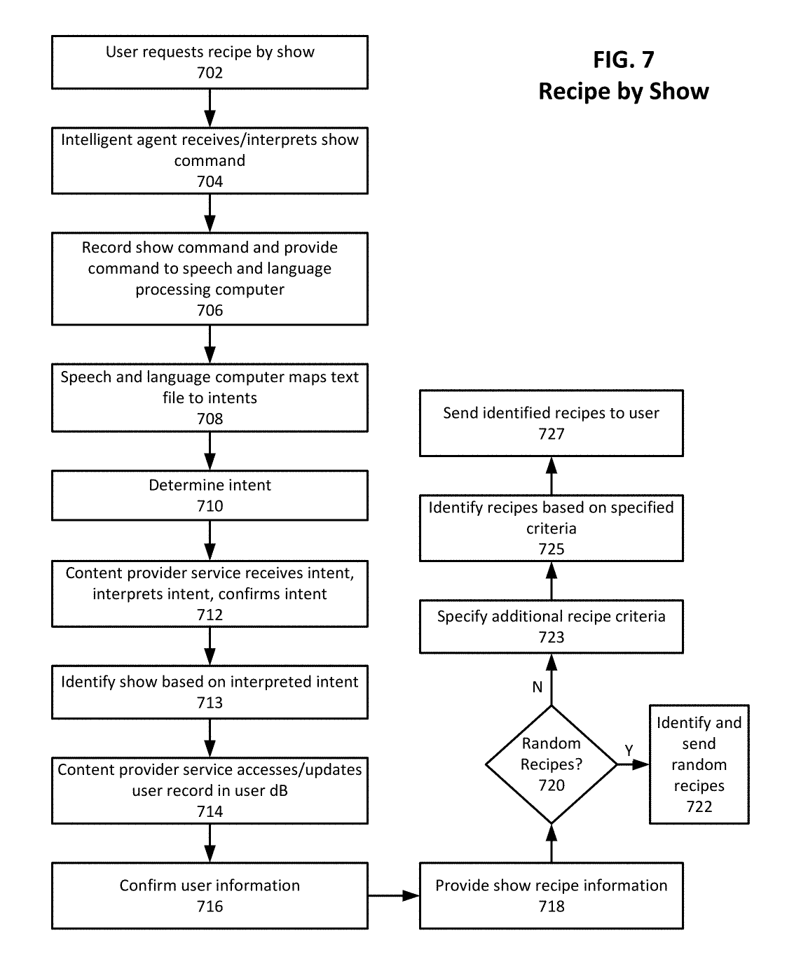

In block 501A of FIG. 5A, a content provider service 180 broadcasts video content C that is displayed on television 106. In block 501B, the user 102 views the video content C. In block 502 a user 102 speaks to voice-activated intelligent agent 104 to initiate access of the content provider service 180. The user 102 may need to activate the voice-activated intelligent agent 104 using a particular phrase or keyword or wake word (e.g., “start” or “launch” or “Alexa” or another wake word) to initiate access. A user 102 can access the system 100 with other commands to request different and additional information regarding channels, shows, recipes, and talent as well.

In one example of the invention, in block 504, the voice-activated intelligent agent 104 receives a command from the user 102 and interprets the command using speech recognition module 210. The voice-activated intelligent agent 104 records the command as an audio file using the processor 201 and memory 202, including operating system 209, and saves the file in audio file buffer 212, which is a computer-readable memory that can be separate from memory 202 (as shown in FIG. 2) or can be integrated with memory 202. The audio file can be stored in a variety of formats, such as .mp3, .m4a, .wav, .aac, .aiff, .au, and other audio formats, such as audio/basic, audio/flac, audio/Ilb, audio/mulaw, audio/ogg, audio/way, audio/webm, and other formats.

In block 506, the voice-activated intelligent agent 104 provides (e.g., transmits) the audio file to the speech and language processing computer 110, which translates the audio file into a text file using automated speech recognition (ASR) module 305 as described below with regard to block 508. The particular ASR process can vary by manufacturer of the voice-activated intelligent agent 104, by speech and language processing computer 110, by the language for recognition, by the content provider 180, and by the manner and type of request. The ASR processing provides independent, computer-driven transcription of spoken language into readable text in real-time. The speech-recognition portion of the system 100 (including intelligent agent 104 and speech and language processing computer 110) identifies the words that the user 102 speaks and converts them to written text. The text file can be saved in different formats as well, including .docx, .txt, .pdf, .srt, and other text formats. The speech and language processing computer 110 stores the text file in a text file database 315.

The intelligent agent 104 and the speech and language processing computer 110 work in tandem to convert a user's spoken request to a text command that is serviced by the content provider service 180. In block 508, the intelligent agent 104 and speech and language processing computer 110 analyze the text file to identify commands (a.k.a. “utterances”) and map a user's spoken input (e.g., commands) to the intents that the content provider service 180 can provide that fulfill the user's spoken request. Sample commands (utterances) are stored in a commands database 317 and reflect likely requests that connote intents. Intents are the underlying action(s) that the user 102 would like to happen that the content provider service 180 can provide and are stored in an intents database 319 in speech and language processing computer 110 or can be stored in a database maintained by the intelligent agent 104. As shown in FIG. 4, content provider service 180 can also include an intents database 419, which can be used to confirm intents identified by the speech and language processing computer 110 and to send intents records to speech and language processing computer 110 to update its intents database 319. As with many of the other databases in the system 100, the text file database 315, the command database 317, the slots database 354, and the intents database 319 can be combined into one or more databases or can remain physically separate from each other. Each of the databases 315, 317, 319 is accessible via network 199. Intents can also have arguments called slots. A set of sample utterances are mapped to the intent. The text command provides a specific intent representing the user's overall request based on a sample utterance. In one example implementation of the invention, the content provider service 180 provides a program for delivering a recipe to a user. The intent is defined as Recipe with slots called fromShow, byChef, onWhen, and onDate.

A user can then request:

“Ask Food Network for the recipe that's on TV right now.”

The slots can include target slots, which can denote a channel, for example. In the above example, “Food Network” is a target slot (e.g., fromShow). The slots can also include deliverables slots, which can denote a digital content item in which the user is interested. In the above example, “a recipe” is a deliverables slot. As outlined above, other slots can include temporal attributes (e.g., onWhen, onDate, etc.) and other attributes (e.g., talent as described by the byChef slot). The slots can be stored in slots database 454 shown in FIG. 4.

Returning to FIG. 5A, in block 510, the speech and language processing computer 110 found a match of the translated text file and a command and identified the desired request and intent (underlying action). When the speech and language processing computer 110 does not find a match of the translated text file and a command in block 510, the intelligent 104 can indicate that no match was found and respond to the user with a clarification request (e.g., a prompt, such as, “I don't understand. What would you like to do?”) as indicated by reference numeral 512A in FIG. 5A. The user 102 would then provide a response to the prompt in block 5128.

In block 514 of the above example, the intelligent agent 104 and the speech and language processing computer 110 sends the Food Network service (part of content provider service 180) a Recipe intent with the value “right now” in the onWhen slot. The Food Network service (content provider service 180) can then save this information in block 516 and send back an underlying action (as text) to the language processing computer 110 and the intelligent agent 104 to be converted to speech as described below.

Slots are words or phrases that represent variable information and are used as effective replacements for the variable words in the utterance. For the identified slots, a slot type can be defined. The onDate and onWhen slots in the above example can use a web service's built-in date types to convert words that indicate dates (such as “today” and “next Thursday,” for example) into a date format, while both fromShow and byChef use a customized list of show slots and chef slots, respectively, which are used to reference shows and chefs by name. The invention can also use external libraries of slot types in addition to types that convert data such as dates and numbers and those that provide recognition for lists of values.

The sample utterances specify the words and phrases users can say to invoke the intents. Each intent is mapped to multiple sample utterances. Slots are indicated within the utterances. In the example above, the utterance for Food Network includes the onWhen slot. For each intent slot, the Food Network service (content provider service 180) determines whether the slot value is required in order to fulfill the request and stores prompts and utterances that the intelligent agent 104 uses in the conversation to elicit the slot. When a slot is required, the Food Network service 180 determines whether the user must explicitly confirm the slot value before the recipe identification program 182 skill completes the request. The Food Network service 180 includes determined prompts that the intelligent agent 104 can use to ask for confirmation. For the entire intent, the Food Network service 180 determines and stores prompts to make when the user must explicitly confirm the action before the recipe identification program 182 completes the request. The service 180 can narrow down ambiguous requests with additional queries/prompts to the user to arrive at a determinative intent, such as a determinative schedule and a determined recipe or recipes, for example. Once all the intents are defined, the interaction model and dialog model is built.

In one example implementation of the invention, the interaction model and dialog model provide the invocation name (Food Network), intent schema (Recipe delivery), and sample utterances in a JSON format, but the speech and language processing computer 110 and the content provider service 180 also can exchange requests and actions using other forms of data structures and node package manager files/packages, including BSON (binary JSON) and others to allow representation of data types that are not a part of the JSON spec. For brevity and convenience, in this disclosure, the node package manager (npm) file is referred to as the JSON package and is used to connote the file holding records and metadata used to carry out actions by the computing devices and to exchange files and records between the computing devices.

Once the invocation name, intent, and utterance is determined by the speech and language processing computer 110, the request is sent to the content provider service 180 over communications network 199. The content provider service 180 modifies and appends the received JSON package to service the request. That is, the JSON package is appended as the content provider 180 accesses various components and services to respond (take action) to the intent.

The system 100, including the content provider 180, periodically reviews the stored text files to develop new “utterances” and “intents” to provide additional functionality and capabilities to the user 102 as actions in response to user requests.

As outlined above, in block 518, the content provider service 180 acts upon the received JSON package that includes the intent from the speech and language processing computer 110. The content provider service 180 includes an application program interface (API) gateway 181 that provides an entry and exit point to the components and services (shown in FIG. 4) of the content provider service 180, such as business logic, data, analytics, and other “back-end” services. The API gateway 181 receives the intent from the speech and language processing computer 110. To the API gateway 181, the intent serves as a request for the content provider service 180 to take an action and provide a response to the user. As outlined above, the intent can be in the form of a JSON package that includes files and metadata relevant to the requested intent. The API gateway 181 can also receive the request in the form of other data structures, including BSON (binary JSON) that can contain extensions that allow representation of data types that are not a part of the JSON spec. The API gateway 181 can also receive the intent as a MessagePack, YAML, and other data serialization formats. The content provider service 180 can include programs and instructions in any programming language, including Java and JavaScript (Node.js), for example. The content provider service 180 includes a platform adapter 150 written in Node.js that includes instructions that when executed by the processor 444 converts incoming requests and outgoing responses from a platform specific format to a common internal format using platform adapter 150.

Once the API gateway 181 receives the JSON package with the intent, in block 520 the content provider service 180 processes the intent by processing the JSON package. For example, the content provider service 180 identifies its recipe identification program 182 as the program with which the user wants to interact based on the user's invocation name and intent schema. The content provider service 180 can also compare an application ID in the JSON package to the content provider service ID established when publishing the application and making it available to users. The content provider service 180 modifies the JSON package to include a supported ApplicationIds confirmation record. In one implementation of the invention, the recipe identification program 182 is a Rails program written in the Ruby programming language, but other frameworks and languages can also be used. In addition to identifying the recipe program as that with which the user wants to interact, the content provider service 180 processes the intent schema and utterance from the JSON package and determines that the user requested a recipe that is appearing on a current broadcast, such as on the Food Network.

To identify the recipe, in block 522 the content provider service 180 looks up the user's identification provided by the intelligent agent 104 and the speech and language processing computer 110 (and embodied in the JSON package) in user database 162. In one example implementation of the invention, user database 162 is an object-relational database in content provider 180 as shown in FIG. 4. However, the user database 162 can be located elsewhere on the network 199, such as in a cloud-hosted database or other web service. In one implementation of the invention, user database 162 is a PostgreSQL database hosted in a centralized provider using Internet-based access protocols.

If the content provider service 180 does not find the user identification record, the content provider service 180 creates the record and appends the JSON package to include the user identification record, such as in block 524. For example, the first time a particular user 102 requests a recipe from the Food Network content provider service 180, the user record is created and stored in user database 162. Subsequent requests from that same user 102 access the already-created user record from user database 162. Similarly, the user's time zone is used to confirm broadcast scheduling but if the user's time zone is recorded as part of the user record in the user database 162, there is no need to request it again from the user, and the process continues. If the user's time zone is not recorded in the user database 162, but it was provided in the JSON package delivered by the intelligent agent 104 and the speech and language processing computer 110 to the API gateway 181 of the content provider service 180, the content provider service 180 updates the user record in the user database 162 to include the (new) time zone information, and the process continues. When the user's time zone is not recorded in the user database 162, and it was not provided in the JSON package delivered to the content provider service 180 by the intelligent agent 104 and the speech and language processing computer 110, the recipe identification program 182 will ask the user to identify it, as in the dashed lines of block 526A and 526B. In one example implementation of the invention, the recipe identification program 182 assembles a JSON package response by accessing prompts database 183. Prompts database 183 includes the determined prompts to be sent back to the intelligent agent 104 and played to the user 102 to ask for confirmation of a variable or action. The recipe identification program 182 assembles the JSON package (prompt) response and sends it to the speech and language processing computer 110 and the intelligent agent 104 to request further information and confirmation from the user 102. For example, in one implementation of the invention shown in block 526A, the recipe identification program 182 assembles and sends the prompt in the appended JSON package to the intelligent agent 104 as a verbal prompt, which is read to the user in block 5268:

“I'll need to know your time zone. Are you in Eastern, Mountain, Central or Pacific?”)

The recipe identification program 182 “session” remains “open” so that the user 102 can continue to interact with the program 182, and can respond appropriately. The process continues as the user responds by speaking, for example, as shown in block 527:

“Eastern.”

In block 528, the intelligent agent 104 and the speech and language processing computer 110 prepares and delivers the response to the program prompt by appending and returning the JSON package with the correct time zone (“Eastern”). The content provider service 180 updates the user record in the user database 162 with the correct time zone in block 530, and the process continues.

In block 532, the recipe identification program 182 determines the current time and prepares a request for the show and recipes on now, updates the JSON package to reflect the request, and sends the request via the API 184. In one example implementation of the invention, the API 184 is a private Food Network Mobile API, such as Food Network “Pantry,” which is a Rails app via a Ruby gem. In other example implementations of the invention, the API is built on a Django framework supporting Python languages. Other example implementations of the API can use other web frameworks and programs to deploy the application.

In block 534, the API 184 uses the request (JSON package) to check the schedule database 175, which includes database records for every day, hour, half hour, and other time slots that correspond to the TV schedule of the content provider service 180 in block 536. The API 184 (Pantry) retrieves an episode identifier from the database records in schedule database 175 to find the correct show (e.g., Barefoot Contessa) and episode (S22E07) that corresponds to the current time in the content database 185. The database record includes a list of recipe identification numbers (IDs), which denote recipes relevant to that particular show/episode.

If the show does not have any recipes associated with it, the API 184 modifies the JSON package to include a response and notifies the user 102 in block 538 (e.g., “The Barefoot Contessa episode currently airing does not include any recipes.”). The system 100 can ask the user 102 if they would like to make another recipe request as part of the JSON package that includes an appropriate prompt in block 539A. If the user 102 makes another recipe request, the process restarts. If the user 102 does not make another recipe request in block 5396 and 540, the process stops.

When the particular show/episode has recipes associated with it, the API 184 (Pantry) appends the JSON package to indicate recipes are associated with the show/episode and returns the appended JSON package to the recipe identification program 182 that includes the show and episode information, along with a list of recipe IDs and summary details. In block 542, the recipe identification program 182 further assembles the response in the JSON package, including a prompt, and returns the JSON package to the speech and language processing computer 110 and the intelligent agent 104 in block 544, where the appended JSON package is translated into speech and played for the user 102 on intelligent agent 104 in block 546:

“We've got some great recipes from this episode of Barefoot Contessa, including ‘Perfect Roast Chicken.’ Would you like me to send you these recipes?”

The JSON package can also provide the response from the content provider service 180 using Speech Synthesis Markup Language (SSML) to provide additional control over the manner in which the intelligent assistant 104 generates the speech from the text in the returned JSON package. While the intelligent agent 104 can accommodate normal punctuation, such as pausing after a period, or speaking a sentence ending in a question mark as a question, SSML provides a way to mark up the text for the generation of synthetic speech. For example, the content provider service 180 may want a longer pause within the speech, or may want a string of digits read back as a standard telephone number. Modifying the JSON package with the SSML markup extends the capabilities of the intelligent agent 104.

Continuing in FIG. 5B, if the user 102 does not answer affirmatively in blocks 548 and 550, the recipe identification program 182 can assemble another response in an appended JSON package that includes a clarification prompt, and return the appended JSON package to the speech and language processing computer 110 and the intelligent agent 104 in block 552 to confirm a user's intent (e.g., “Are you watching Barefoot Contessa?”) in block 553. When the user 102 confirms the title of the show in block 554, the process continues to block 556. When the user 102 does not confirm the title of the show in block 554, the content provider service 180 provides a notification to the user 102 via speech and language computer 110 and intelligent agent 104 as shown in blocks 558 and 559. Additional prompts can be sent to the user by further appending the JSON package to further clarify the user's intent. For example, the intelligent agent 104 can notify the user 102 that the show currently on the air could not be confirmed (e.g., “The Barefoot Contessa is currently airing in your time zone. Is the Barefoot Contessa on your screen?”), and the system 100 can ask the user 102 if they would like to make another recipe request. If the user 102 makes another recipe request, the process restarts. If the user 102 does not make another recipe request, the process stops.

When the user 102 verbally responds to the prompt in the affirmative in block 556 (“Yes”), the intelligent agent 104 and the speech and language processing computer 110 translates the verbal response and returns a request to the content provider service 180 via the appended JSON package with the answer (“Yes”) in block 560.

The content provider service 180 receives the updated JSON package with the answer (“Yes”). In some example implementations of the invention, the content provider service 180 accesses the user database 162 and determines the user's preferred medium for receipt of the recipe in block 562. For example, the user 102 can specify that they would prefer to receive the recipes via e-mail, in which case, the content provider service 180 looks up and retrieves the user's e-mail address in the user database 162. If the user's email address is recorded in the user database 162, there is no need to request it from the user. If the user's e-mail address is not recorded in the user database 162, but it was provided in the JSON packages delivered to the API gateway 181 of the content provider service 180 by the intelligent agent 104 and the speech and language processing computer 110, the content provider service 180 updates the user record in the user database to include the (new) e-mail address and appends the JSON package to reflect the update.

When the user's e-mail address is not recorded in the user database 162, and it was not provided in a JSON package delivered to the content provider service 180 by the intelligent agent 104 and the speech and language processing computer 110, the recipe identification program 182 asks for it by further appending the JSON package and sending it to the user via speech and language processing computer 110 and intelligent agent 104 in blocks 564 and 566. In one example implementation of the invention, the recipe identification program 182 assembles an updated JSON package that includes a response by accessing prompts database 183. As above, prompts database 183 includes the determined prompts to be sent back to the intelligent agent 104 and played to the user to ask for confirmation of a variable or action. As part of blocks 564 and 566, the recipe identification program 182 assembles the (prompt) response and sends it to the speech and language processing computer 110 and the intelligent agent 104 to request further information and confirmation from the user. If the intelligent agent 104 requires account linking (e.g., Amazon Alexa), the recipe identification program 182 assembles a response (“I'll need your email address to send your recipes, please provide it in the Alexa app”) in the updated JSON package and returns it to the speech and language processing computer 110 and the intelligent agent 104. The session ends while the user provides the e-mail address in the account linking application.

If the intelligent agent 104 allows for requesting e-mail access (e.g., Google Assistant), recipe identification program 182 assembles the JSON package to include a response and prompt in blocks 564 and 566 (“Food Network is asking for your email address, would you like to provide it?”) and returns the appended JSON package to the speech and language processing computer 110 and the intelligent agent 104. In this example implementation of the invention, where the intelligent agent 104 does not require account linking, the recipe identification program 182 keeps the session “open” after block 566 so that the user 102 can continue to interact with the program 182, and can respond appropriately. The process continues as the user responds in block 568 by speaking:

“Yes, JohnDoe123@rocketmail.com”

The intelligent agent 104 and the speech and language processing computer 110 prepares and delivers the response to the program prompt by returning a JSON package with the user's e-mail address (“Yes, JohnDoe123@rocketmail.com”) to the content provider service 180 in block 570. In block 572, the content provider service 180 updates the user record in the user database 162 with the correct e-mail address.

Similarly, the user may wish to receive the recipes in some other form, including by text message to a computing device, such as computing devices including smart phones 108, laptop computers 109, tablet 110, and other computing devices. Other users may wish to receive the recipes in an audio file sent to a voice mail account. Other users may prefer to receive the recipes as video file, while others may want to receive the recipes in audio form spoken by the intelligent agent 104. The content provider service 180 can accommodate and deliver the recipes in the various formats preferred by the users and based upon the type of device upon which the user will receive the recipe file.

In block 574, the recipe identification program 182 makes a request for the full recipe details from the Food Network Mobile API 184 (Pantry), which accesses the recipe database 170 in block 576 for each recipe identification number (ID). In block 578, the API 184 (Pantry) returns an appended JSON package that includes recipe details, including photos, directions, ingredients, grocery lists, show titles, episode names, chef, time to cook, and other information relevant to the recipe.

In block 580, the recipe identification program 182 assembles an e-mail newsletter using an HTML/Rails template with details about each recipe and links to the full recipes on Foodnetwork.com and other attributes culled from the updated JSON package, and sends the e-mail to the user via a mail server 486 in block 582. The mail server 486 can use Simple Mail Transfer Protocol (SMTP) to transfer the e-mail from the content provider service 180 to the user 102. Once the content provider service sends the e-mail to the user, the recipe identification program 182 assembles a response (“Okay, I've send those recipes to your e-mail address. Happy cooking!”) in a further updated JSON package and returns it to the speech and language processing computer 110 and the intelligent agent 104 in block 584, where it is converted to speech and played for the user in block 586 on the intelligent agent 104 to notify the user 102 that the recipe was sent. Upon successfully identifying, locating, and sending the recipes to the user 102, the system 100 pauses and listens for additional user utterances/commands.

In addition to a user 102 request recipe information based upon the content C that is currently broadcast, users can also ask for recipes by a particular show, by a particular chef (or talent), by a time/date, by ingredients, by theme (e.g., season of year, religious occasions, other celebrations, etc.) and by other intents.

### Request Recipe by Show

As outlined above, when requesting recipe information, users can also ask for recipes from a particular show provided as video content C from the content provider service 180. In this case, when a user 102 requests recipe information (e.g., “Send me recipes from Giada at Home on Food Network.”), the content provider service 180 determines that the user 102 is requesting recipes related to a particular show. The invention uses a similar process to that outlined above to identify and deliver recipes.

For example, a user 102 speaks to voice-activated intelligent agent 104 saying, “Ask Food Network for recipes from Giada at Home” or otherwise requests a show in block 702, and the voice-activated intelligent agent 104 receives the command and interprets the command using the speech recognition module 210 in block 704.

As above, the voice-activated intelligent agent 104 records the command as an audio file and provides the audio file to the speech and language processing computer 110 in block 706, which translates the audio file into a text file using an automatic speech recognition (ASR) module 305 and the natural language processing (NLP) module 308. The intelligent agent 104 and speech and language processing computer 110 identifies the words and phrases that the user 102 speaks and converts those words to written text. In block 708, the intelligent agent 104 and speech and language processing computer 110 maps a user's spoken input (e.g., commands) to the intents that the content provider service 180 can provide that fulfill the user's spoken request. The speech and language processing computer 110 stores the text file in a text file database 315 and determines an intent in block 710. The structured text files are sample utterances that connect spoken phrases to an intent that the user has. The intent is a JSON (JavaScript Object Notation) structure that declares the set of actions that can be accepted and processed by the content provider service 180.

In block 712, the content provider service 180 identifies the utterance and interprets the utterance as a desired request with an intent to access Giada at Home® (i.e., the show). The content provider service 180 accesses content database 185 and compares the name of the show from the audio-to-text file that the user 102 spoke to names of shows in the content database 185. From this comparison, the content provider service 180 determines the name of the show in block 713 (e.g., Giada at Home). The content provider service 180 responds with an updated JSON package that is translated by the speech and language processing computer 110 into an audio message to the user 102 played through the voice-activated intelligent agent 104, such as, “Giada at Home is one of the most popular shows on Food Network.” As before with the request for the recipe “on now,” in block 714, the content provider service 180 accesses user database 162 to lookup user information. If the user 102 has previously accessed the voice-activated intelligent agent 104, user database 162 includes an account record for the user 102, and the process proceeds from block 714 to block 716.

If no account record for the user 102 exists in user database 162, the content provider service 180 assumes that the user 102 is accessing the voice-activated intelligent agent 104 for the first time and creates a record as part of block 714, and the voice-activated intelligent agent 104 asks for additional set-up information, such as user name, email address, text message number, and similar identifying information. Subsequent requests from that same user 102 access the created user record. As was the case above, a user's identifying information is recorded and stored in the user record in user database 162 and is updated when necessary (e.g., when it is not already part of the record, when it is delivered as part of the JSON packaged delivered to the API gateway 181 of the content provider service 180) or when the recipe identification program 182 asks for it. In one example implementation of the invention, the recipe identification program 182 assembles a response by accessing prompts database 183. Prompts database 183 includes the determined prompts to be sent back to the intelligent agent 104 and played to the user to ask for confirmation of a variable or action. The recipe identification program 182 assembles the (prompt) response and sends it to the speech and language processing computer 110 and the intelligent agent 104 to request further information and confirmation from the user. For example, in one implementation of the invention, the recipe identification program 182 assembles and sends the prompt in a JSON package to the intelligent agent 104 requesting the user's identifying information, including email address and other information.

If the content provider service 180 understood the user 102 uttering valid user information (e.g., email address, etc.), the process continues to block 716 and the intelligent agent 104 confirms the user's information (e.g., “I set your email address as JohnDoe@rocketmail.com.”). If the content provider service 180 does not understand the user 102 to be uttering valid user information in block 716, the intelligent agent 104 and the speech and language processing computer 110 requests clarification, such as the intelligent agent 104 responding by playing a message (e.g., “Sorry, I don't know that email provider.”) and again requesting the user information. Also, if the intelligent agent 104 does not understand the user 102 to be uttering valid user information, the recipe identification program 182 can set the user account to a default (e.g., “gmail.com”) and request confirmation by the user. Similarly, the recipe identification program 182 can request the user's street address or zip code or other user location-specific information.

Once the user information and/or user record is set in block 716, the process continues to block 718 where the intelligent agent 104 provides a show status (e.g., “I can provide many recipes from Giada at Home.”) The intelligent agent 104 can ask the user 102 if the identified show is correct (e.g., “Do you want to receive recipes from Giada at Home?”) and the user 102 can confirm. If the show status is incorrect in block 718, the user 102 can indicate as such (e.g., “No”), and the process can return to block 716 where the system can update the user record and access the schedule database 175 and the content database 185.

Once the content provider service 180 identifies the show, the content provider service 180 can respond to the user 102 by asking the user 102 if they want random recipes in block 720. If the user 102 would like to receive random recipes, the process moves to block 722, where the content provider service 180 locates and selects one or more recipes from the recipe database 170 and the content database 185 based upon a selection algorithm or an algorithm established by the system 100 to deliver a variety of recipes to the user in the recipe file. The selection algorithm can include temporal criteria (e.g., “send the user the three most recent recipes,” “send the user one beef, one chicken, and one vegetarian recipe”) or criteria linked to advertising or other influences (“send the user the three recipes that carry the most expensive advertisements”). The content provider service 180 updates the JSON package with the new recipe information, including recipe text, recipe photos, and links to other pages in which the user 102 may be interested. The content provider service 180 electronically sends the JSON package to the speech and language processing computer 110 and intelligent agent 104 in block 720.

In block 720, if the user 102 does not want to receive random recipes from the show, and instead has more specific recipe criteria in mind, the content provider service 180 can send prompts and other requests that the user 102 provide criteria from which the content provider service 180 can identify and send recipes to the user 102. For example, in block 723 a user 102 may indicate that they want to receive recipes from the most recently aired Giada at Home episode or provide additional recipe criteria that serves to characterize recipes in which the user 102 is interested. Another example is where users may request recipes from a Giada at Home holiday show, or they may request recipes that include a particular keyword (e.g., Giada's Chicken Florentine).

In any case, the content provider service 180 identifies the recipe criteria based upon the command and intent files and based on the actual day and time of the received request and the user's time zone. The content provider service 180 accesses the schedule database 175 and identifies the dates and time that episodes of the show aired (e.g., Giada at Home aired last Friday at 10 AM and 1030 AM, and aired last Saturday at 8 AM). When the content provider service 180 determines that the user 102 is requesting a recipe from the most recent Giada at Home episode, the content provider service 180 narrows the search in block 462 and matches an episode from the schedule database 175 to recipes that aired on that most recent episode in the recipe database 170. The system 100 identifies recipes in the recipe database 170 that match the criteria in block 725, and the system 100 locates the recipes in the recipe database 170 and selects the recipes based upon the selection criteria provided by the user 102.

As above, the system 100 can deliver recipe files to the user 102 as the updated JSON package in the form of an email, text message, as well as in the form of a video file, audio file, and other digital formats, depending upon the device upon which the user 102 will receive the recipe file. As above, the delivery means and other preferences can be specified by the user 102 when initially setting up the user account and can be changed using system utilities. In block 727, the content provider service 180 sends the recipes and notifies the user 102 that the recipes were sent. Upon successfully identifying, locating, and sending the recipes to the user 102, the system 100 pauses and listens for additional user utterances/commands.

### Request Recipe by Channel

As outlined above, the invention can provide access to video content C from content provider service 180 based on channels, shows, recipes, talent, and other criteria. For example, when the content provider service 180 determines a user request relates to starting a channel (e.g., accessing recipe information based on a particular channel), the invention uses a similar process to that outlined above to identify and deliver recipes.

For example, a user 102 speaks to voice-activated intelligent agent 104 saying, “Start Food Network” or “Launch Food Network” or otherwise requests a channel in block 602, and the voice-activated intelligent agent 104 receives the command and interprets the command using the speech recognition module 210 in block 604.

As above, the voice-activated intelligent agent 104 records the command as an audio file and provides the audio file to the speech and language processing computer 110 in block 606, which translates the audio file into a text file using an automatic speech recognition (ASR) module 305 and the natural language processing (NLP) module 308. The intelligent agent 104 and speech and language processing computer 110 identify the words and phrases that the user 102 speaks and converts those words to written text. The speech and language processing computer 110 stores the text file in a text file database 315 and determines an intent in block 610. The structured text files are sample utterances that connect spoken phrases to an intent that the user has. The intent is a JSON (JavaScript Object Notation) structure that declares the set of actions that can be accepted and processed by the content provider service 180.

In block 612, the content provider service 180 identifies the utterance and interprets the utterance as a desired request with an intent to access Food Network® (i.e., the channel). The content provider service 180 responds with an updated JSON package that is translated by the speech and language processing computer 110 into an audio message to the user 102 played through the voice-activated intelligent agent 104, such as, “Welcome to Food Network.” As before with the request for the recipe “on now,” in block 614, the content provider service 180 accesses user database 162 to lookup user information. If the user 102 has previously accessed the voice-activated intelligent agent 104, user database 162 includes an account record for the user 102, and the process proceeds from block 614 to block 616.

If no account record for the user 102 exists in user database 162, the content provider service 180 assumes that the user 102 is accessing the voice-activated intelligent agent 104 for the first time and creates a record as part of block 614, and the voice-activated intelligent agent 104 asks for additional set-up information, such as user name, email address, text message number, time zone, and similar identifying information. Subsequent requests from that same user 102 access the created user record. As was the case above, a user's time zone is recorded in the user record in user database 162 and is updated when necessary (e.g., when it is not already part of the record, when it is delivered as part of the JSON packaged delivered to the API gateway 181 of the content provider service 180) or when the recipe identification program 182 asks for it. In one example implementation of the invention, the recipe identification program 182 assembles a response by accessing prompts database 183. Prompts database 183 includes the determined prompts to be sent back to the intelligent agent 104 and played to the user to ask for confirmation of a variable or action. The recipe identification program 182 assembles the (prompt) response and sends it to the speech and language processing computer 110 and the intelligent agent 104 to request further information and confirmation from the user. For example, in one implementation of the invention, the recipe identification program 182 assembles and sends the prompt in a JSON package to the intelligent agent 104 requesting the user's time zone.

If the content provider service 180 understood the user 102 uttering a valid time zone, the process continues to block 614 and the intelligent agent 104 confirms the user's time zone (e.g., “I set you to the Pacific time zone.”). If the content provider service 180 does not understand the user 102 to be uttering a valid time zone in block 614, the intelligent agent 104 and the speech and language processing computer 110 requests clarification, such as the intelligent agent 104 responding by playing a message (e.g., “Sorry, I don't know that time zone.”) and again requesting a time zone for the channel programming. Also, if the intelligent agent 104 does not understand the user 102 to be uttering a valid time zone, the recipe identification program 182 can set the user account to a default time zone (e.g., “Eastern”) and request confirmation by the user. Similarly, the recipe identification program 182 can request the user's zip code or other user location-specific information and determine the user's time zone based on the zip code or other location-specific information.

Once the time zone and/or user record is set in block 614, the process continues to block 616 where the intelligent agent 104 provides a channel status (e.g., “Right now, we're five minutes into an episode of ‘Chopped’ on the Food Network.”) The intelligent agent 104 can ask the user 102 if the channel status is correct (e.g., “Are you seeing ‘Chopped’ on your screen?”) and the user 102 can confirm. If the channel status is incorrect in block 616, the user 102 can indicate as such (e.g., “No”), and the process can return to block 614 where the system can update the user record and access the schedule database 175 and the content database 185.

When the user 102 confirms the correct channel status in block 616, the process continues, and the content provider service 180 processes user requests and responds to the user 102 (e.g., “I can tell you about Food Network programming or send show recipes. Which would you like?”). When the user 102 requests recipes in block 618, the process continues in block 620 with the recipes process of FIGS. 5A-5B. If the user 102 does not request recipes in block 618, the process continues to block 622, and the content provider service 180 provides channel and show information (e.g., content) from schedule database 175 and content database 185. If the user 102 did not request programming or shows information in block 618, the intelligent agent 104 responds with a clarification request (e.g., “Sorry, I don't understand your request and the process returns to an idle state awaiting additional requests from the user, or the intelligent agent 104 queries the user 102 for additional commands.

### Request Recipe by Talent

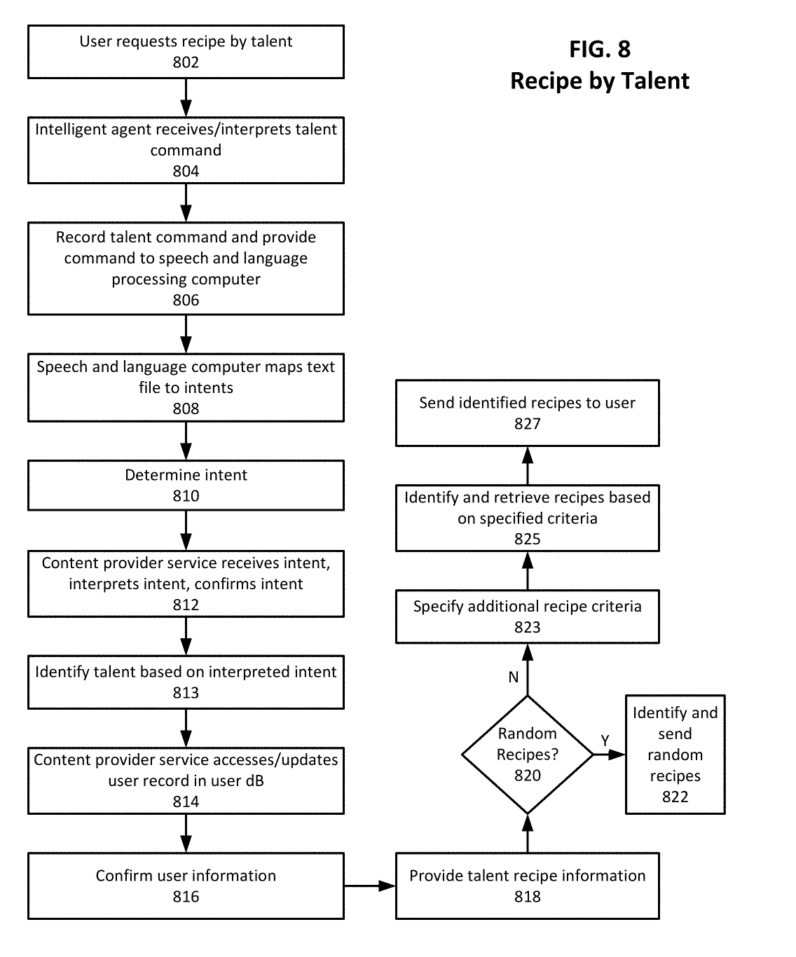

As outlined above, when requesting recipe information, users can also ask for recipes from a particular talent (e.g., television personality, host of a show, chef, and other identifiable person). As shown in the example in FIG. 8, in this case, a user 102 speaks to voice-activated intelligent agent 104 in block 802 saying, “Send me recipes from Giada from Food Network”), and the invention uses a similar process to that outlined above to identify and deliver recipes. As before, the voice-activated intelligent agent 104 receives the command and interprets the command using the speech recognition module 210 in block 804.

As above, the voice-activated intelligent agent 104 records the command as an audio file and provides the audio file to the speech and language processing computer 110 in block 806, which translates the audio file into a text file using an automatic speech recognition (ASR) module 305 and the natural language processing (NLP) module 308. The intelligent agent 104 and speech and language processing computer 110 identifies the words and phrases that the user 102 speaks and converts those words to written text. In block 808, the intelligent agent 104 and speech and language processing computer 110 maps a user's spoken input (e.g., commands) to the intents that the content provider service 180 can provide that fulfill the user's spoken request. The speech and language processing computer 110 stores the text file in a text file database 315 and determines an intent in block 810. The structured text files are sample utterances that connect spoken phrases to an intent that the user has. The intent is a JSON (JavaScript Object Notation) structure that declares the set of actions that can be accepted and processed by the content provider service 180.

In block 812, the content provider service 180 identifies the utterance and interprets the utterance as a desired request with an intent to access recipes from a talent (e.g., “Ask Food Network for recipes from Giada.”). The content provider service 180 accesses talent database 160 and compares the name of the talent from the audio-to-text file that the user 102 spoke to names of talent in the talent database 160. From this comparison, the content provider service 180 determines the name of the talent in block 813 (e.g., Giada DeLaurentiis). Once the content provider service 180 identifies the talent, the content provider service 180 responds with an updated JSON package that is translated by the speech and language processing computer 110 into an audio message to the user 102 played through the voice-activated intelligent agent 104, such as, “Giada DeLaurentiis is one of the most popular chefs on Food Network.” As before with the request for the recipe “on now,” in block 814 the content provider service 180 accesses user database 162 to lookup user information. If the user 102 has previously accessed the voice-activated intelligent agent 104, user database 162 includes an account record for the user 102, and the process proceeds from block 814 to block 816.

If no account record for the user 102 exists in user database 162, the content provider service 180 assumes that the user 102 is accessing the voice-activated intelligent agent 104 for the first time and creates a record as part of block 814, and the voice-activated intelligent agent 104 asks for additional set-up information, such as user name, email address, text message number, and similar identifying information. Subsequent requests from that same user 102 access the created user record. As was the case above, a user's identifying information is recorded and stored in the user record in user database 162 and is updated when necessary (e.g., when it is not already part of the record, when it is delivered as part of the JSON packaged delivered to the API gateway 181 of the content provider service 180) or when the recipe identification program 182 asks for it). In one example implementation of the invention, the recipe identification program 182 assembles a response by accessing prompts database 183. Prompts database 183 includes the determined prompts to be sent back to the intelligent agent 104 and played to the user to ask for confirmation of a variable or action. The recipe identification program 182 assembles the (prompt) response and sends it to the speech and language processing computer 110 and the intelligent agent 104 to request further information and confirmation from the user. For example, in one implementation of the invention, the recipe identification program 182 assembles and sends the prompt in a JSON package to the intelligent agent 104 requesting the user's identifying information, including email address and other information.

As before, if the content provider service 180 understood the user 102 uttering valid user information (e.g., email address, etc.), the process continues to block 816 and the intelligent agent 104 confirms the user's information. If the content provider service 180 does not understand the user 102 to be uttering valid user information in block 816, the intelligent agent 104 and the speech and language processing computer 110 requests clarification or set the user account to a default and request confirmation by the user or request other user-specific information.

Once the user information and/or user record is set in block 816, the process continues to block 818 where the intelligent agent 104 provides a talent status (e.g., “I can provide many recipes from Giada DeLaurentiis.”). The intelligent agent 104 can ask the user 102 if the identified talent is correct (e.g., “Do you want to receive recipes from Giada DeLaurentiis?”) and the user 102 can confirm. If the show status is incorrect in block 818, the user 102 can indicate as such (e.g., “No”), and the process can return to block 816 where the system can update the user record and access the schedule database 175 and the content database 185.

Once the content provider service 180 identifies the talent, the content provider service 180 can respond to the user 102 by asking the user 102 if they want random recipes in block 820. If the user 102 would like to receive random recipes, the process moves to block 822, where the content provider service 180 locates and selects one or more recipes from the recipe database 170 in conjunction with the talent database 160 and the content database 185 based upon a selection algorithm or an algorithm established by the system 100 to deliver a variety of recipes to the user in the recipe file (JSON package). As before, the selection algorithm can include temporal criteria (e.g., “send the user the three most recent Giada recipes,” “send the user one beef, one chicken, and one vegetarian Giada recipe”) or criteria linked to advertising or other influences (“send the user the three Giada recipes that carry the most expensive advertisements”). The content provider service 180 updates the JSON package with the new recipe information, including recipe text, recipe photos, and links to other pages in which the user 102 may be interested. The content provider service 180 electronically sends the JSON package to the speech and language processing computer 110 and intelligent agent 104 in block 822.

In block 820, if the user 102 does not want to receive random recipes from the show, and instead has more specific recipe criteria in mind, the content provider service 180 can send prompts and other requests (e.g., “What type of Giada recipe are you looking for?”) that the user 102 provide criteria from which the content provider service 180 can identify and send recipes to the user 102. For example, in block 823 a user 102 may indicate that they want to receive recipes from the most recently aired Giada at Home episode or provide additional recipe criteria that serves to characterize recipes in which the user 102 is interested. Another example is where users may request recipes from a Giada at Home holiday show, or they may request recipes that include a particular keyword (e.g., Giada's Chicken Florentine). If the user 102 provides additional recipe criteria in block 823 (e.g., “Send me Giada's chicken recipes.”), the content provider service 180 retrieves the recipe criteria in block 825 and converts the received recipe criteria audio-to-text file to search the recipe database 170 to narrow the identified recipes (e.g., Giada recipes with chicken). The generated recipe criteria can include number and temporal criteria, such as the three most recent recipes shown by Giada DeLaurentiis. Likewise, the additional recipe criteria can include preparation time, such as those recipes shown by Giada DeLaurentiis that can be prepared in under 40 minutes. Other recipe criteria can also be used to narrow the recipe results to a subset of all recipes in recipe database 170 shown by Giada DeLaurentiis.

In any case, the content provider service 180 identifies the recipe criteria based upon the command and intent files and based on the actual day and time of the received request and the user's time zone. The content provider service 180 accesses the schedule database 175 and identifies the dates and time that episodes of the show aired (e.g., “Giada at Home aired last Friday at 10 AM and 1030 AM, and aired last Saturday at 8 AM”). When the content provider service 180 determines that the user 102 is requesting a recipe from the most recent Giada at Home episode, the content provider service 180 narrows the search in block 462 and matches an episode from the schedule database 175 to and the content database 185 and the talent database 160 to identify recipes in the recipe database 170 that aired on the most recent episode. The system 100 identifies recipes in the recipe database 170 that match the criteria in block 825, and the system 100 locates the recipes in the recipe database 170 and selects the recipes based upon the selection criteria provided by the user 102 and builds a JSON package including the recipe delivery file that includes recipe text, recipe photos, and links to other pages in which the user 102 may be interested.

As above, the system 100 can deliver recipe files to the user 102 as the updated JSON package in the form of an email, text message, as well as in the form of a video file, audio file, and other digital formats, depending upon the device upon which the user 102 will receive the recipe file. As above, the delivery means and other preferences can be specified by the user 102 when initially setting up the user account and can be changed using system utilities. In block 827, the content provider service 180 sends the recipes and notifies the user 102 that the recipes were sent. Upon successfully identifying, locating, and sending the recipes to the user 102, the system 100 pauses and listens for additional user utterances/commands.

### Request Recipe by Other Intent

In additional to requesting recipes that are now airing, recipes that are from a particular channel or show, and recipes that are from a particular talent, users can utter additional recipe information using a different recipe-based command and intent (e.g., “Ask Food Network for the three most popular recipes.”) to initiate a system search of the recipe database 170 in order to receive a recipe delivery file (JSON package) with recipe information. The system 100 evaluates the user's command to determine the user's intent. For example, when a user 102 does not request a recipe that is on now, nor a recipe from a channel or a show, nor a recipe from a talent, the system 100 uses the voice-activated intelligent agent 104 to receive the command/utterance from the user 102 and interpret the command using speech recognition module 210. As above, the voice-activated intelligent agent 104 records the command as an audio file using the processor 201 and memory 202, including operating system 209 and saves the file in audio file buffer 212.

If the system 100 is unable to determine or identify the user's command or request, or if the user's intent is not evident from the command, the intelligent agent 104 can responds with a clarification request (e.g., “Sorry, I don't understand”) and/or a prompt to solicit additional information from the user 102, or the recipe request process could restart with another request. To determine the “other” intent, the voice-activated intelligent agent 104 provides (e.g., transmits) the audio file to the speech and language processing computer 110, which translates the audio file into a text file using automated speech recognition (ASR) module 305. The speech-recognition portion of the system 100 (including intelligent agent 104 and speech and language processing computer 110) identifies the words that the user 102 speaks and converts them to written text. The speech and language processing computer 110 stores the text file in a text file database 315.

As before, the intelligent agent 104 and the speech and language processing computer 110 work in tandem to convert a user's spoken request to a text command that is serviced by the content provider service 180. The intelligent agent 104 and speech and language processing computer 110 maps a user's spoken input (e.g., commands) to the intents that the content provider service 180 can provide that fulfill the user's spoken request. Additional sample commands/utterances are stored in commands database 317 and reflect likely requests that connote intents and are mapped to intents. Intents are the underlying action that the user 102 would like to happen that the content provider service 180 can provide and are stored in an intents database 319 or be stored in a database maintained by the intelligent agent 104.

The speech and language processing computer 110 finds a match of the translated text file and a command and identified the desired request and intent (underlying action). As before, when the speech and language processing computer 110 does not find a match of the translated text file and a command, the intelligent 104 can indicate that no match was found and respond to the user with a clarification request (e.g., “I don't understand. What would you like to do?”).

For example, the content provider service 180 identifies an intent from the user's commands and the intended recipe characteristics identified in the user's recipe request (e.g., “Send me Food Network's three most popular recipes,” “Send me two recipes for chicken,” Send me Food Network's recipes for chicken that do not include garlic”). The content provider service 180 accesses recipe database 170 and compares the keywords/intent identified from the audio-to-text file that the user 102 spoke to keywords/intents of recipes in the recipe database 170. The system 100 narrows down the list of recipes with the identified intent and identifies other recipe characteristics that are used with the identified intent.

As above, the content provider service 180 API gateway 181 provides an entry and exit point to the components and services of the content provider service 180. The API gateway 181 receives the intent from the speech and language processing computer 110. To the API gateway 181, the intent serves as a request for the content provider service 180 to take an action and provide a response to the user. As outlined above, the new intent can be in the form of a JSON package that includes metadata relevant to the requested intent.

Once the API gateway 181 receives the intent, the content provider service 180 processes the intent. For example, the content provider service 180 identifies its recipe identification program 182 as the program with which the user wants to interact based on the user's invocation name and intent schema. In addition to identifying the recipe program as that with which the user wants to interact, the content provider service 180 processes the intent schema and utterance and determines that the user requested a recipe that includes chicken.

Once the content provider service 180 identifies recipe characteristics, the content provider service 180 can respond to the user 102 by asking the user 102 if they want to provide additional criteria in addition to the determined intent (e.g., “Do you want chicken dishes without garlic that include broccoli?”), and the prompt is delivered from the content provider service 180 to the speech and language processing computer 110 and the intelligent agent 104 in a similar manner as described above. In structuring system responses to request a defined number of user replies, the system culls the number of possible commands and intents that the user may provide to a manageable number. That is, the system provides improved speech recognition efficiency by limiting the number of “valid” commands and intents with which a user may respond to a predefined number and type. If the user 102 provides additional recipe criteria (e.g., “Yes, I want broccoli”). The system 100 converts the response to the prompt from an audio-to-text file and determines additional recipe criteria (e.g., broccoli). The content provider service 180 receives the additional recipe criteria and searches the recipe database 170 to narrow the identified recipes further based on the user's additional criteria and selects the recipes based upon the selection criteria provided by the user 102.

If the system 100 is unable to identify any narrowed recipes in the databases 160, 170, 185 the system 100 notifies the user 102 (e.g., “Food Network does not include any chicken recipes with broccoli and without garlic.”) and can ask the user 102 if they would like to make another recipe request. If the user 102 makes another recipe request, the process begins again. If the user 102 does not make another recipe request, the process stops.

As before, the content provider service can sends the identified recipes to the user via e-mail, and the recipe identification program 182 can assemble a response (“Okay, I've sent those recipes to your e-mail address. Happy cooking!”) in a JSON package and return it to the speech and language processing computer 110 and the intelligent agent 104, where it is converted to speech and played for the user on the intelligent agent 104 to notify the user 102 that the recipes were sent. Upon successfully identifying, locating, and sending the recipes to the user 102, the system 100 pauses and listens for additional user utterances/commands.

### Multiple Command and Intents

Users can combine multiple commands and intents, and the system 100 can take appropriate action to service these requests. For example, a user 102 may ask, “What is on Food Network on Thursday at 8 PM?” As before, the user's sample utterances are converted to structured text files that connect spoken phrases to an intent that the user has. The intent as a JSON package is a structure that declares the set of actions that can be accepted and processed. The system 100 interprets the verbal utterance as a desired request for programming information for a specific time (Thursday at 8 PM).

The speech and language processing computer 110 determines multiple intents from the utterance and takes action(s) to service the command. In this example, the speech and language processing computer 110 identifies multiple intents and sends the determined intents to the content provider service 180, which accesses the schedule database 175 and the content database 185 and provides a response that includes multiple programming information (e.g., This Thursday at 8 PM Eastern, you can watch Diners, Drive-ins, and Dives.”). As before, the content provider service 180 takes into account the user's location information, including time zones and other account information when responding to the user request.

Other examples of users uttering commands that result in multiple intents include requesting programming information for a particular content source at a particular time and can be structured in a number of different ways. The system can interpret the intents and request clarification information if necessary. For example, a user may ask, “What is on Food Network on Friday,” and the system can respond with a clarifying question such as, “Do you want programming information for Friday morning, Friday afternoon, or Friday evening?” Once the user provides the clarifying information, the system can provide additional specific programming information.

### CONCLUSION

The claimed invention provides a speech recognition and digital content distribution system that includes an intelligent agent, such as Amazon Alexa, Google Assistant, Microsoft Cortana, Apple Homepod, and others, that receives and records a user command as an audio file. A speech and language processing computer translates the audio file into text and creates a text file. The speech and language processing computer compares the text file and identified words and phrases to sample utterances and intents developed by a digital content provider. When the speech and language processing computer matches the text file to sample utterances and intents, the system identifies the user's command and takes action to service the command in response to the user's intent. The content provider accesses a number of different databases to take actions include identifying digital content provided by the content provider, provide recipes or other materials prepared and shown by the digital content provider, and identify talent appearing on the digital content. The system requests clarifying information from the user when more than one intent or action can be determined or serviced. The action file can send responses to the user including electronic responses, verbal responses, and video responses.

We claim:

1. A content provider computer comprising:
at least one processor;
a memory;
one or more computer programs, wherein the one or more computer programs are stored in the memory and configured to be executed by the at least one processor, the one or more programs including instructions for:
receiving a JSON package from a speech and language processing computer, wherein the JSON package includes a messaging intent determined by performing natural language processing on text data, and the text data is generated from an audio file by performing automated speech recognition;
decoding the JSON package to identify the messaging intent, wherein the messaging intent corresponds to an action to be taken by the content provider computer;
determining at least one digital content item that satisfies the action of the messaging intent;
appending the JSON package to include the at least one digital content item; and
providing the appended JSON package with the at least one digital content item to the speech and language computer over a communications network.

2. A content provider computer of claim 1, wherein the one or more computer programs includes a recipe identification program including additional instructions for:
further decoding the JSON package and determining that the messaging intent includes delivery of a recipe and that the at least one digital content item includes a recipe.

3. A content provider computer of claim 2, wherein the one or more computer programs includes a recipe identification program including additional instructions for:
further decoding the JSON package and
comparing the decoded JSON package to intents records in an intents database in the content provider computer.

4. A content provider computer of claim 2, wherein the one or more computer programs includes a recipe identification program including additional instructions for:
further decoding the JSON package and
determining that the messaging intent includes a slot pattern including at least a target slot and a deliverables slot.

5. A content provider computer of claim 4, wherein the one or more computer programs includes a recipe identification program including additional instructions for:
determining the portion of the JSON package that corresponds to the target slot and the deliverables slot and that the target slot includes a television program that is currently broadcast and that the deliverables slot includes a recipe related to the television program that is currently broadcast.

6. A content provider computer of claim 5, wherein the one or more computer programs includes a recipe identification program including additional instructions for:
comparing the target slot to a schedule database; and
determining a television program that is currently broadcast based on schedule records in the schedule database that correspond to the target slot; and
comparing the deliverables slot to a recipe database; and
determining at least one recipe related to the television program based on recipe records in the recipe database that correspond to the deliverables slot.

7. A content provider computer of claim 6, wherein the one or more computer programs includes a recipe identification program including additional instructions for:
identifying the television program that is currently broadcast based on television program records in a content database in the content provider computer.

8. A content provider computer of claim 4, wherein the one or more computer programs includes a recipe identification program including additional instructions for:
determining a time zone of a user based on at least one of a known user identification record, a portion of the JSON package that corresponds to a time zone record, and a response to a prompt from the content provider computer requesting the time zone of the user.

9. A content provider computer of claim 4, wherein the one or more computer programs includes a recipe identification program including additional instructions for:
determining the portion of the JSON package that corresponds to the target slot and the deliverables slot and that the target slot includes a talent name and that the deliverables slot includes a recipe related to the talent name.

10. A content provider computer of claim 9, wherein the one or more computer programs includes a recipe identification program including additional instructions for:
comparing the target slot to a talent database that includes talent records with television program information;
comparing the talent records to a schedule database to determine broadcast dates and times of television programs featuring talent identified in the talent records;
determining a television program based on the talent records and the schedule records in the schedule database that correspond to the target slot;
comparing the deliverables slot to a recipe database; and
determining at least one recipe related to the television program based on recipe records in the recipe database that correspond to the deliverables slot.

11. A content provider computer of claim 1, wherein the one or more computer programs includes additional instructions for:
confirming receipt of the appended JSON package by the speech and language processing computer and playback of a generated audio response corresponding to the appended JSON package by an intelligent agent computing device.

12. A content provider computer of claim 1, wherein the one or more computer programs includes additional instructions for:
further decoding the JSON package to identify a user;
comparing the identified user to user records in the user database of the content provider computer; and
confirming the user identity based on the comparison of the identified user and the user records.

13. A content provider computer of claim 9, wherein the one or more computer programs includes additional instructions for:
determining that the user does not correspond to a user record in the user database of the content provider computer;
identifying a prompt in a prompts database in the content provider computer that corresponds to a user's time zone; and
modifying the JSON package to include the prompt; and
providing the appended JSON package with the prompt to the speech and language computer over a communications network; and
confirming receipt of the modified JSON package by the speech and language processing computer and playback of a generated audio response corresponding to the modified JSON package by an intelligent agent computing device, resulting in an audio prompt to a user requesting the user's time zone.

14. A content provider computer of claim 1, wherein the one or more computer programs includes additional instructions for:
identifying a prompt in a prompts database in the content provider computer and
modifying the JSON package to include the prompt; and
providing the appended JSON package with the prompt to the speech and language computer over a communications network; and
confirming receipt of the modified JSON package by the speech and language processing computer and playback of a generated audio response corresponding to the modified JSON package by an intelligent agent computing device, resulting in an audio prompt to a user.

15. A content provider computer of claim 1, wherein the audio file generated by performing automated speech recognition includes speech data from a user received by a microphone of an intelligent agent computing device.

16. A content provider computer of claim 1, wherein the one or more computer programs includes additional instructions for:
sending the at least one digital content item to a user in an email over a communications network with a mail server of the content provider computer.

17. A content provider computer of claim 1, wherein the one or more computer programs includes additional instructions for:
sending the at least one digital content item to a user in a text message over a communications network.
